(19) United States
(12) Patent Application Publication
(10) Pub. No.: US 2006/0082554 A1
(43) Pub. Date: Apr. 20, 2006

(54) Integrated input roller having a rotary mass actuator

(75) Inventors: Michael E. Caine, Needham, MA (US); Angela Chang, Cambridge, MA (US); David B. Cranfill, Antioch, IL (US); Richard A. Thrush, Garwood, NJ (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/962,300

(22) Filed: Oct. 8, 2004

(51) Int. Cl. G09G 5/08

(52) U.S. Cl. 345/167

(57) ABSTRACT

An input roller device (50) includes a roller (58), an eccentric rotating mass (59) within the roller, a drive mechanism (54, 56 and 57) causing the eccentric rotating mass to rotate within the roller, and a processor (52) coupled to the drive mechanism. The drive mechanism can also optionally include a drive link (57) if not directly driven by the shaft of the motor. The input roller device 50 can further include a rotary encoder (60) coupled to the roller such that the rotary encoder can provide data to the processor on a rotation of the roller. Note, the processor can be programmed to cause the input roller to provide a varied tactile feedback to the user to correspond to different events or to cause the input roller to provide a rolling resistance that varies in coordination with inputs from a user interface.

### FIELD OF THE INVENTION

This invention relates generally to user interfaces, and more particularly to input roller devices providing feedback effects.

### BACKGROUND OF THE INVENTION

Many input devices used to control portable electronic devices provide specific tactile responses to a user that do not vary with time or usage modality. Such devices typically employ fixed mechanical devices, such as domed popples or mechanical springs and detents to provide tactile feedback to a user. Nonetheless, such input devices, such as these “passive” scroll wheels, cannot vary their tactile feedback under software control. Such passive scroll wheels fail to enrich a user's interaction experience to the fullest extent.

### SUMMARY OF THE INVENTION

By combining the advantages of a rotary mass vibrator with a force-feedback scroll wheel, a richer set of tactile responses, triggered by software, can be experienced by a user. Embodiments in accordance with the invention provide a means for delivering to a user a time varying, mode specific tactile response that can be controlled by software to enrich a user's interaction experience by providing an additional mode of communication between the user and their device.

In accordance with a first embodiment of the present invention, an input roller device can include a roller, an eccentric rotating mass within the roller, a drive mechanism causing the eccentric rotating mass to rotate within the roller, and a processor coupled to the drive mechanism. The roller can be mounted in the hinge of a clam shaped electronic device for example or a roller on a different portion of an electronic device and the drive mechanism can include at least one among an electric motor, a drive circuit coupled to the electric motor, and software to control the processor and drive circuit. The eccentric rotating mass can include at least one magnet coupled to the roller. More specifically, the eccentric rotating mass can include a magnetic clutch that couples the motor to the roller. The input roller device can further include a rotary encoder coupled to the roller such that the rotary encoder can provide data to the processor on a rotation of the roller. Note, the processor can be programmed to cause the input roller to provide a varied tactile feedback to the user to correspond to different events or to cause the input roller to provide a rolling resistance that varies in coordination with inputs from a user interface.

In a second embodiment of the present invention, an electronic device having an input roller device can include a roller, an eccentric rotating mass within the roller, a drive mechanism causing the eccentric rotating mass to rotate within the roller, and a processor coupled to the drive mechanism. The input roller device can further include a rotary encoder coupled to the roller that can provide data to the processor on a rotation of the roller. The electronic device can be a cellular phone, a two-way radio, a messaging device, a mouse, a personal digital assistant, a lap top computer, an MP3 player, a video player or almost any electronic device having a roller-type input device. As noted above, the processor can be programmed to cause the input roller to provide a varied tactile feedback to the user to correspond to different events or to cause the input roller to provide a rolling resistance that varies in coordination with inputs from a user interface.

In a third embodiment of the present invention, a method of providing user feedback using an input roller device can include the steps of causing an eccentric mass to rotate within a roller of the input roller device responsive to movement of the input roller device and varying a tactile feedback to a user using the eccentric mass to correspond to different events occurring at an electronic device having the input roller device. The step of varying the tactile feedback can optionally include the step of varying a rolling resistance in coordination with inputs from a user interface. The method can further include the step of encoding data corresponding to a rotation of the roller.

### BRIEF DESCRIPTION OF THE DRAWINGS

FIG. 1 is a perspective view of a device in a closed position having an integrated input roller and rotary mass actuator in accordance with an embodiment of the present invention.

FIG. 2 is a perspective of the device of FIG. 1 in an open position in accordance with an embodiment of the present invention

FIG. 3 is a schematic diagram of the device of FIG. 1 illustrating the components of an integrated input roller and rotary mass actuator in accordance with an embodiment of the present invention.

FIG. 4 is the schematic diagram of the device of FIG. 3 further illustrating a mode of use of the integrated input roller and rotary mass actuator in accordance with an embodiment of the present invention

FIG. 5 is a schematic diagram of the device of FIG. 1 further illustrating the operation of the integrated input roller and rotary mass actuator in accordance with an embodiment of the present invention.

FIG. 6 is a block diagram of another device having an integrated input roller and rotary mass actuator in accordance with an embodiment of the present invention.

FIG. 7 is a flow chart illustrating a method of providing user feedback using an input roller device in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

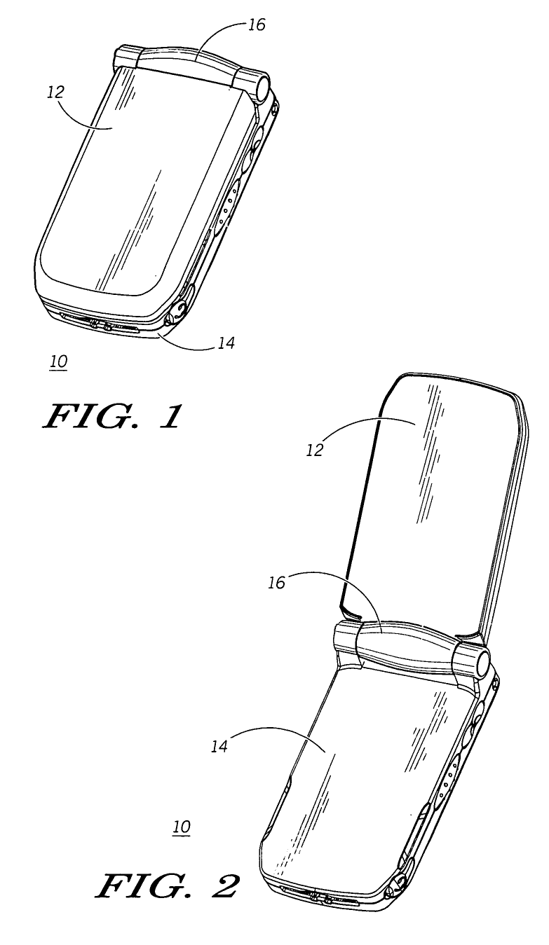

Input devices such as rollers or scroll wheels are used to encode input from a human user as part of the physical user interface of electronic devices such as portable electronic devices. The data from such input devices is interpreted by a processor as part of the operating software of the device. In one embodiment in accordance with the present invention and with reference to FIGS. 1-5, a small electric motor 18 and an eccentric rotating mass 24 is integrated into a roller 16 used to scroll through lists of data on a portable electronic device 10. In this instance, the portable electronic device 10 can be a flip phone having a flip 12 and base potion 14 with a hinge roller 16 coupled between the flip 12 and base portion 14. In one mode of operation, the motor 18 can be used to spin the eccentric rotating mass 24 to a prescribed rotational velocity. During this mode of operation, the user's finger is not in contact with the roller, so that the resulting vibratory effect produced by the roller is felt by the user holding the electronic device. In another mode of operation, the user's finger is in contact with the roller 16, thereby producing a resistance to the rotation of the roller 16. In this mode, the sense of tactile feedback experienced by the user is produced by the force applied to the user's finger by the torque of the motor 18. A rotary encoder 32 can be used to transmit data on the rotation of the roller 16 back to a processor (not shown, but see FIG. 6). This data could include inputs from the user when the user is actively scrolling the device, or data on the position or velocity and acceleration of the roller 16, to be used for control purposes, when the roller 16 is used to generate vibration effects. Depending on the design and size of the motor 18, the connection between the motor and the roller is made through a mechanical transmission to both reduce the speed and increase the effective torque of the motor at the roller. The rotary encoder 32 could be driven directly from the roller, or can be mounted as part of the motor system. The motor system can further include a keeper bearing 30 and keeper spring 34 as well as a keeper bearing 22. Additionally, the motor 18 can be powered and controlled via wiring 20 as illustrated in FIG. 4.

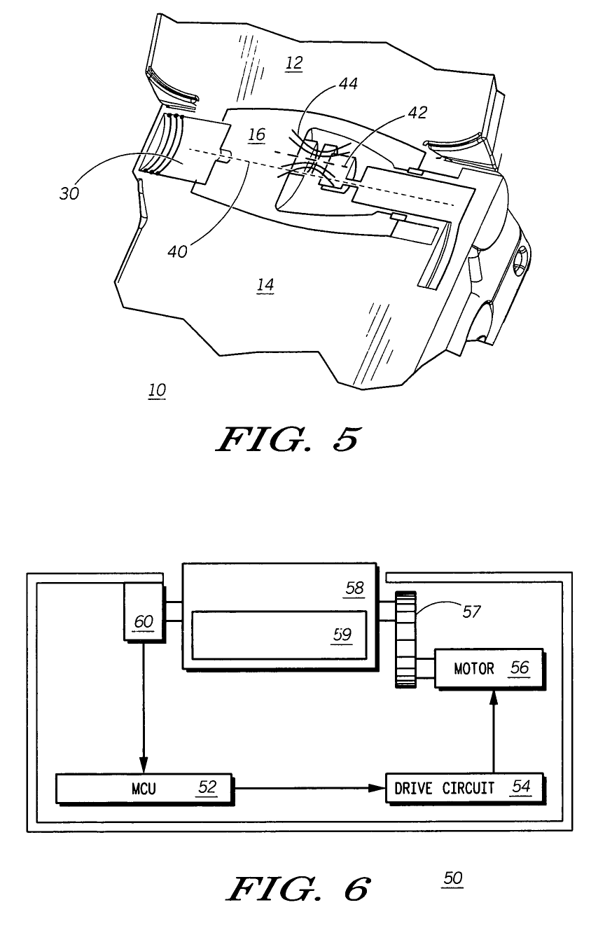

Referring once again to FIG. 4, roller 16 can serve as a mechanism for providing haptic feedback via a user interface. Note that the flip form factor allows access to the roller 16 in the open or closed positions although embodiments in accordance with the present invention are not necessarily limited to electronic devices in a flip form. A monolith form factor or other form factors can also utilize the benefits claimed and discussed herein. As can be seen in FIGS. 4 and 5, the vibrator motor 18 inside the hinge roller 16 uses a magnetic flux coupling to transmit torque to spin the roller 16 with 2 degrees of freedom. In one instance the roller 16 and motor counter weight 24 spin together or in another instance the motor counter weight 24 spins and the roller stays still. To generate sufficient coupling in this small space, magnets 26 and 28 such as powerful Neodymium-Iron-Boron magnets are used. As shown in FIG. 5, the centerline of the magnets 42 and of the representative flux coupling 44 is off set from the motor (and roller) centerline 40 to transmit the required torque. Also note that the keeper 30 can be hollowed and slotted to accommodate flex circuitry (not shown).

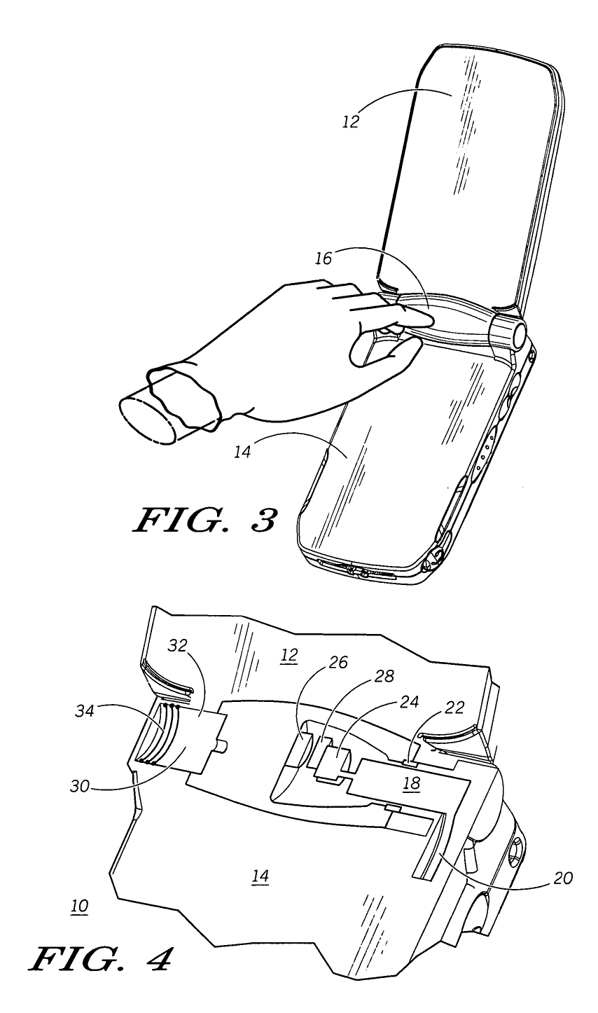

As previously explained above, the forces felt by the user can have two modes. In a first mode, the mass of magnets 26 and 28 can form part of the vibrator counterweight which produces the acceleration forces felt by the user, as experienced in a typical phone vibrator. In a second mode, when the user is using the roller 16, tactile feedback can be directly applied to the user's finger as shown in FIG. 3. The magnetic flux coupling 44 illustrated in FIG. 5 can provide the user with a resistance force against the rotation of the roller 16 by the user.

As in other applications using haptics, if additional haptic texture is desired, the motor 18 can be bi-directionally driven using H-Bridge circuitry to be able to apply torque against the direction of scrolling, or with, or to superimpose a subtle vibration texture. If the bi-directional option is applied, then this mechanism could be used to implement real-time interactive haptics between two phone users. In a simple example, if a message such as “LOL” for “laugh out load” in a Instant Messaging Application between two users is sent, the receiving phone can vibrate automatically upon detecting such message.

There are many additional use case examples of which only a few are presented. In the case where a phone is in a user's pocket and the vibrator alert goes off, if the roller 16 can move, it spins and shakes the phone due to it's off center counter weighting (magnets and motor counter weight). If the roller 16 can't move (constrained by the user's pocket or otherwise), the motor spins anyway and shakes the phone due to its magnet and counterweight and overcomes the magnetic coupling with the roller. In another instance, when the phone is not in a vibrate alert mode, the coupling of the roller/vibrator magnets can keep the motor directly coupled to the roller, allowing for subtle vibrotactile user feedback. More specifically, if a user is scrolling through a menu with the roller and software can indicate that the user has reached the end of the list, the motor can be programmed to “fight” the direction the user is spinning the roller by applying a pulse of torque in the opposite direction. In another example, as a user scrolls over names in a user interface phonebook, a short, subtle torque pulse can give a “speed bump” effect as each name is scrolled by. In yet another use case, graphics can be printed on the roller, so that when it spins quickly, it forms desired images and patterns that cannot be seen when the roller is still. Control of the rotational velocity of the roller 16 via software can enable viewing of such images and patterns. Different patterns and images can also be presented at different rotation speeds. Further note, any time the roller is spinning it can be touched and stopped by the users hand, causing no harm to the user or the motor (the motor never stalls because it is stronger than the magnetic coupling).

The device described above including the motor 18 can certainly be used as a rotary alert vibrator. If the roller 16 is mounted in a clam-style cellular telephone, for example, then this mode of operation would be applied while the phone is in the closed configuration as shown in FIG. 1. When the phone is in the open configuration as shown in FIG. 2, and the user's finger is placed on the surface of the roller as shown in FIG. 3, then the resulting force may be used to provide tactile feedback to the user. In a phonebook application, for example, the force applied to the user's finger may be used to signify that the user has scrolled from names beginning with “B” to names beginning with “C”. Since the force is controlled by software, it may be varied as necessary to correspond to different events or actions.

In another application where the user's finger is not in contact with the roller, and when the motor is accelerated or decelerated under software control, the user would perceive an acceleration that is a combination of the acceleration of the motor and acceleration due to the rotation of the eccentric mass. Variations in timing between the application of acceleration/deceleration pulses, and the relative position of the eccentric, mass may be used to create richer tactile responses as discussed above.

Referring to FIG. 6, a block diagram of an input roller device 50 including a roller 58, an eccentric rotating mass 59 within the roller 58, a drive mechanism (54, 56 and 57) causing the eccentric rotating mass 59 to rotate within the roller, and a processor 52 coupled to the drive mechanism is shown. The roller 58 once again can be a hinge roller on a clam shaped electronic device for example (as previously shown in FIGS. 1-5) or a roller on a different portion of an electronic device and the drive mechanism can include at least one among an electric motor 56, a drive circuit 54 coupled to the electric motor 56, and software to control the processor 52 and drive circuit 54. Based on the configuration of the drive mechanism, the drive mechanism can also optionally include a drive link 57 if not directly driven by the shaft of the motor 56. The software driving the motor 56 can be resident on the processor 52 itself or in other memory configurations (ROM, RAM, EPROM, Flash memory, etc.) as commonly found in many portable electronic devices. The eccentric rotating mass 59 can include at least one magnet coupled to the roller 58. The input roller device 50 can further include a rotary encoder 60 coupled to the roller 58 such that the rotary encoder 60 can provide data to the processor 52 on a rotation of the roller 58. Note, the processor 52 can be programmed to cause the input roller 58 to provide a varied tactile feedback to the user to correspond to different events or to cause the input roller 58 to provide a rolling resistance that varies in coordination with inputs from a user interface. Note, some embodiments herein will not provide a roller with a variable resistance. Although the rotational position on the roller can change by moving the position of the eccentric mass and/or magnet on the motor using the magnetic torque transmitted, the magnetic torque is not necessarily varied. For variable magnetic torque on the roller, the magnetic flux coupling can be changed to vary the resistance or torque strength of the roller using any number of methods such as applying a variable current to an electromagnet (instead of a ferromagnet or permanent magnet) or changing the positioning between magnets for example.

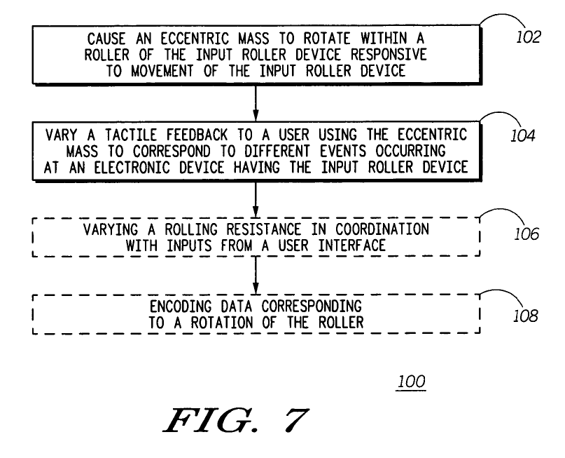

Referring to FIG. 7, a method 100 of providing user feedback using an input roller device can include the step 102 of causing an eccentric mass to rotate within a roller of the input roller device responsive to movement of the input roller device and the step 104 of varying a tactile feedback to a user using the eccentric mass to correspond to different events occurring at an electronic device having the input roller device. The step 104 of varying the tactile feedback can optionally include the step 106 of varying a rolling resistance in coordination with inputs from a user interface. The method 100 can further include the step 108 of encoding data corresponding to a rotation of the roller.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. An input roller device, comprising:
a roller;
an eccentric rotating mass within the roller;
a drive mechanism causing the eccentric rotating mass to rotate within the roller; and
a processor coupled to the drive mechanism.

2. The input roller device of claim 1, wherein the roller is a hinge roller on a clam shaped electronic device.

3. The input roller device of claim 1, wherein the drive mechanism comprises an electric motor.

4. The input roller device of claim 1, wherein the drive mechanism comprises at least one among an electric motor, a drive circuit coupled to the electric motor, and software to control the processor and drive circuit.

5. The input roller device of claim 1, wherein the input roller device further comprises a rotary encoder coupled to the roller.

6. The input roller device of claim 5, wherein the rotary encoder provides data to the processor on a rotation of the roller.

7. The input roller device of claim 1, wherein the eccentric rotating mass comprises at least one magnet coupled to the roller.

8. The input roller device of claim 1, wherein the processor is programmed to cause the input roller to provide a varied tactile feedback to the user to correspond to different events.

9. The input roller device of claim 1, wherein the processor is programmed to cause the input roller to provide a rolling resistance that varies in coordination with inputs from a user interface.

10. An electronic device having an input roller device, comprising:
a roller;
an eccentric rotating mass within the roller;
a drive mechanism causing the eccentric rotating mass to rotate within the roller; and
a processor coupled to the drive mechanism.

11. The input roller device of claim 10, wherein the roller is a hinge roller and the electronic device is a clam shaped electronic device.

12. The electronic device of claim 10, wherein the drive mechanism comprises at least one among an electric motor, a drive circuit coupled to the electric motor, and software to control the processor and drive circuit.

13. The electronic device of claim 10, wherein the input roller device further comprises a rotary encoder coupled to the roller.

14. The electronic device of claim 10, wherein the electronic device is selected among a cellular phone, a two-way radio, a messaging device, a mouse, a personal digital assistant, a lap top computer, an MP3 player, and a video player.

15. The electronic device of claim 10, wherein the processor is programmed to cause the input roller to provide a varied tactile feedback to the user to correspond to different events.

16. The electronic device of claim 10, wherein the processor is programmed to cause the input roller to provide a rolling resistance that varies in coordination with inputs from a user interface.

17. The electronic device of claim 12, wherein the electronic motor serves as a rotary alert vibrator.

18. A method of providing user feedback using an input roller device, comprising the steps of:
responsive to movement of the input roller device, causing an eccentric mass to rotate within a roller of the input roller device;
varying a tactile feedback to a user using the eccentric mass to correspond to different events occurring at an electronic device having the input roller device.

19. The method of claim 18, wherein the method further comprises the step of encoding data corresponding to a rotation of the roller.

20. The method of claim 18, wherein the method further comprises the step of varying a rolling resistance in coordination with inputs from a user interface.
